(19) United States
(12) Patent Application Publication
(10) Pub. No.: US 2014/0344046 A1
(43) Pub. Date: Nov. 20, 2014

(54) ELECTRONIC PAYMENT SYSTEM WITH PAYER CONTROLLED TRANSACTION FEES AND VARIABLE REBATE CAPABILITIES

(71) Applicant: Bottomline Technologies (DE) Inc., Portsmouth, NH (US)

(72) Inventors: Christopher Curtis Martin, Portsmouth, NH (US); Amy Beth Hoke, Gilford, NH (US); Robert Arntz Eberle, North Hampton, NH (US); Eric Kevin Morgan, Epping, NH (US)

(21) Appl. No.: 14/448,565

(22) Filed: Jul. 31, 2014

Related U.S. Application Data
(62) Division of application No. 13/200,581, filed on Sep. 26, 2011.
Application No. 13/200,581 is a continuation-in-part of application No. 13/136,728, filed on Aug. 9, 2011, now Pat. No. 8,521,646.
Application No. 13/136,728 is a continuation-in-part of application No. 13/068,558, filed on May 13, 2011.

(51) Int. Cl. G06Q 20/24; G06Q 30/02

(52) U.S. Cl. CPC G06Q 20/24; G06Q 30/0234
USPC 705/14.34; 705/39

(57) ABSTRACT

A system makes payments from each payer of a community of payers to each vendor of a community of vendors, assesses a variable transaction fee to each vendor, and provides a variable rebate to the payer. The transaction fee is referred to as “variable” because: i) it may be varied amongst vendors (the same payer may use different rates for different vendors); and ii) the rate may be varied amongst payers (the same vendor may be subjected to different rates, based on the particular payer making the payment). The transaction fee may be charged to the vendor by deduction from the payment. Alternatively the transaction fee may be charged to the vendor by deduction from the vendor's account at the time payment is made. The variable rebate is based on the total transaction fee applicable to payments made by the payer over a predetermined period of time. The rebate may be the product of the total transaction fee multiplied by a rebate percentage. In a two tier system, the rebate may be the sum of: i) product of the total transaction fee multiplied by a base rebate percentage; and ii) the product of that portion of the total transaction fee in excess of an accelerator threshold multiplied by an accelerated rebate percentage.

### TECHNICAL FIELD

The present invention relates to electronic payment and remittance systems and more particularly, to an electronic payment and remittance system which assesses a variable transaction fee to each vendor and provides a variable rebate to each payer.

### BACKGROUND OF THE INVENTION

Electronic payments are becoming more common place for settling both consumer and business to business transactions. The most common electronic payment mechanism in the consumer world is a payment card such as a credit card, charge card, or debit card. Generally, payment cards are issued by an operator of a card payment system such as American Express or Diners Club (sometimes called a closed loop system), or by a bank or financial institution under licensing from a bank card brand provider such as Visa or Mastercard (formerly bank card associations).

In a card payment system, the financial institution issuing the card handles authorizations and all aspects of the transaction and settles payment with the merchant/vendor and the consumer/cardholder. More specifically, when a consumer pays for a purchase using a credit card issued as part of a card payment system, the merchant/vendor's point of sale terminal is used to obtain, from the issuer, an authorization for the payment amount. The authorization represents a guarantee that the issuer will pay the authorized amount. Once authorization is obtained the merchant/vendor can provide the goods or services without concern as to whether the consumer will pay for the goods or services because consumer credit risk is on the issuer that provided the authorization (guarantee of payment), not the merchant/vendor that obtained the authorization (guarantee of payment). To settle the transaction, the issuer pays the merchant/vendor the authorized amount less a transaction fee. The transaction fee is established by contract between the merchant/vendor and the card payment system operator/issuer at the time the merchant/vendor opens its merchant account with the close loop system operator/issuer.

When a bank or financial institution issues a payment card under licensing from a bank card brand provider such as Visa or Mastercard, the bank is referred to as the Issuing Bank. To accept payment by payment card issued under license from a bank card brand provider, a merchant/vendor opens a merchant account with a bank of financial institution that is also licensed by the bank card brand provider. The bank at which the merchant/vendor has its merchant account is called the Acquiring Bank. The Issuing Bank and the Acquiring Bank may be different banks.

When a consumer pays for a purchase using a payment card licensed under a bank card brand provider, the vendor's point of sale terminal is used to access the brand provider's settlement network and obtain an authorization for the payment amount. The authorization represents a guarantee that the Issuing Bank will fund the authorized amount. Once authorization is obtained, the transaction is processed. More specifically, the Acquiring Bank funds the vendor's Merchant Account with the amount of the transaction less a transaction fee that is established by contract between the Acquiring Bank and the merchant/vendor. The Acquiring Bank obtains payment from the Issuing Bank through the brand provider's settlement network and pays a fee, called an interchange fee, to the brand provider. The brand provider keeps a portion of the interchange fee and credits a portion of the interchange fee back to the Issuing Bank.

The issuer in the card payment model and the Issuing Bank in the bank brand provider model may use a portion of the transaction fee (or the Issuing Bank's portion of the interchange fee) to fund a reward program that provides some financial benefit to the cardholder or, in the case of a commercial card program, rewards back to the company. Examples of reward programs include airline mileage reward programs and cash back rebate programs (for example 1% cash back). The terms and conditions of the reward program, and the financial benefit provided to the cardholder under the reward program, is controlled by the issuer/Issuing Bank.

Further, the issuer in the card payment model and the Issuing Bank in the bank brand provider model may charge the cardholder for use of the card. Such a charge is typically in the form of an annual fee. The amount of any charge to the cardholder is determined by the issuer/Issuing Bank.

It should be appreciated that the cardholder (i.e. the payer) making payment to the merchant/vendor does not determine the transaction fee paid by the vendor. The transaction fee paid by the vendor is determined by the issuer in the card payment model and the Acquiring Bank in the brand provider model.

In the consumer market, card payment has grown dramatically since the first card payment systems were introduced in the late 1940s and 1950s (Diners Club in 1949, American Express in 1959) and the first association branded cards were introduced in 1966 (BankAmericard, which is now VISA, and InterBank Card, which is now MasterCard, both card brand providers). One of the primary drivers of growth has been that merchant/vendors are willing to accept card payments and pay the corresponding transaction fee to eliminate credit risk of the individual consumer purchasing from the merchant/vendor. Once a transaction is authorized, payment to the merchant/vendor is guaranteed.

Recently, card issuers, in particular the bank card brand providers and their participating banks, have been marketing card payments for business to business transactions. In general, an Issuing Bank issues a purchase card to a business and the business uses the card to pay vendors. Vendors must have a Merchant Account with an Acquiring bank and pay the applicable fees as determined by the Acquiring Bank. The Acquiring bank pays an interchange fee on the transaction, at least part of which is paid to the Issuing Bank. Currently purchasing card payments represent less than 4% of the business to business payments in the United States. It is speculated that purchasing card payments are not being adopted for business to business transactions as rapidly as adoption for consumer transactions for at least two reasons. First, most business to business payments are payments in the ordinary course of an ongoing relationship between the vendor and the payer and the vendor sees little credit risk in being paid. As such, the vendor sees little advantage of receiving a guarantee of payment at authorization, and while many vendors may be willing to pay a small transaction fee for the convenience of immediate payments, the guarantee of immediate payment is not enough to justify payment of the high fixed transaction fee charged by the Acquiring Bank. Second, purchase card payments are difficult for both the payer and the vendor to reconcile in their respective accounts payable and accounts receivable accounting systems without at least duplicating manual entry of at least some payment/remittance information in multiple systems.

Even though there has been little adoption of purchase cards and card payments for business to business transactions, business to business payers still seek electronic payment solutions to lower costs associated with traditional check payments, and possible generate revenue from, their accounts payable.

In view of the foregoing, what is needed is an improved an electronic payment and remittance system when enables a payer to determine, on a vendor specific basis, the fee, if any, that the vendor will pay for receipt of payments and the rebate, if any, the payer will receive based on payments to each vendor.

### SUMMARY OF THE INVENTION

A first aspect of the present invention comprises a system for making payments from each payer of a community of payers to each vendor of a community of vendors, assessing a transaction fee to each vendor in conjunction with executing a payment from a payer to the vendor, and providing a variable rebate to the payer.

The transaction fee assessed to the vendor is based on a variable transaction rate. The rate is referred to as “variable” because: i) the rate may be variable amongst vendors, the same payer may use different rates for different vendors; and ii) the rate may be variable amongst payers, the same vendor may be subjected to different rates, based on the particular payer making the payment.

The system includes a payer registry stored in a database encoded to a computer readable memory. The payer registry includes a group of payer records. Each payer record is associated with, and identifies, a unique one of the payers within the community of payers, preferably by unique network ID.

Associated with each payer record may be identification of each vendor within a payer vendor group (i.e. the group of vendors to which the payer makes payment). Each payer vendor group may be unique. More specifically, each payer vendor group may be a subset of the community of vendors that consists of fewer than the entire community of vendors and is distinct from each other payer vendor group.

Associated with each vendor within the payer vendor group may be identification of a payer determined fee rate. The payer determined fee rate may be assigned by the operator of the network based on industry sensitivity (as discussed herein), based on a fee rate in effect for another payer that is already paying the vendor, or manually assigned by, or at the direction of, the payer. Unlike a card network, the payer may have ultimate control over the fee rate, even if initially assigned by the operator of the network, and therefore it is referred to as the payer determined fee rate.

A payment application comprises instructions stored in a computer readable memory and executed by a processor. The payment application receives each payment instruction from each payer. Payment instructions may be batched within a file of payment instructions or may be individual. For purposes of clarity, with respect to a specific payment instruction, the payer making payment is referred to as the transaction payer and the vendor being paid is referred to as the transaction vendor.

In response to each payment instruction, the payment application identifies a transaction fee to assess the transaction vendor by: i) looking up, in the database, the payer determined fee rate associated with the transaction vendor within the payer vendor group associated with the transaction payer; and ii) multiplying the amount of the payment by the payer determined fee rate, such product being the transaction fee (subject to any payer determined maximum or minimum thresholds).

The payment application then credits, to the account of the transaction vendor, a net payment amount equal to the transaction payment amount less the payer determined transaction fee. Credit of the net payment amount may include: i) generating a credit in the amount of the payment less the transaction fee; or ii) generating a credit of the full payment amount and a simultaneous debit of the transaction fee.

The system further includes a rebate application comprising instructions coded to a computer readable memory and executed by a processor. For each payer, the rebate application calculates a rebate over a predetermined period of time, such as one year, by determining a total transaction fee applicable to the payer. The total transaction fee may be the sum of each transaction fee applied to each payment made by the payer during the predetermined period of time.

The rebate may be a function of the total transaction fee. More specifically, in an exemplary single tier system, the rebate amount may be the product of the total transaction fee multiplied by a rebate fractional value between zero and one. In an exemplary two tier system, the rebate amount may be the sum of: i) product of the total transaction fee multiplied by a base rebate fractional value between zero and one; and ii) the product of that portion of the total transaction fee in excess of a predetermined accelerator threshold multiplied by an accelerated rebate fractional value. The combination of the base rebate fractional value and the accelerated rebate fractional value cannot exceed one hundred percent (100%) of the transaction fee charged to the total transaction fees.

For a better understanding of the present invention, together with other and further aspects thereof, reference is made to the following description, taken in conjunction with the accompanying drawings. The scope of the invention is set forth in the appended claims.

### BRIEF DESCRIPTION OF THE DRAWINGS

FIG. 1 is a block diagram representing architecture of a system for making payments from each payer of a community of payers to each vendor of a community of vendors, assessing a variable transaction fee to each vendor, and providing a variable rebate to each payer, all in accordance with an exemplary embodiment of the present invention;

FIG. 2 is a block diagram representing a payer in accordance with an exemplary embodiment of the present invention;

FIG. 3 is a block diagram representing a vendor in accordance with an exemplary embodiment of the present invention;

FIG. 4 is a table diagram representing a matching of sensitivity scores to industry codes in accordance with an exemplary embodiment of the present invention;

FIG. 5 is a table diagram representing data elements stored in, and relationships between data elements stored in, a vendor registry in accordance with an exemplary embodiment of the present invention;

FIG. 6a is a table diagram representing data elements stored in, and relationships between data elements stored in, a payer registry in accordance with a first exemplary embodiment of the present invention;

FIG. 6b is a table diagram representing data elements stored in, and relationships between data elements stored in, a payer registry in accordance with a second exemplary embodiment of the present invention;

FIG. 7a is a flow chart representing a first aspect of operation of a fee tier assignment application in accordance with the present invention;

FIG. 7b is a flow chart representing a second aspect of operation of a fee tier assignment application in accordance with the present invention;

FIG. 7c is a graphic depicting an exemplary user interface for fee tier assignment in accordance with and exemplary embodiment of the present invention.

FIG. 8a is a table diagram representing payer centric spend scores and criteria for determining a payer centric spend score in accordance with an exemplary embodiment of the present invention;

FIG. 8b is a table diagram representing payer centric frequency scores and criteria for determining a payer centric frequency score in accordance with an exemplary embodiment of the present invention;

FIG. 8c is a table diagram representing network spend scores and criteria for determining a network spend score in accordance with an exemplary embodiment of the present invention;

FIG. 8d is a table diagram representing network frequency scores and criteria for determining a network frequency score in accordance with an exemplary embodiment of the present invention;

FIG. 8e is a table diagram representing weight factors to apply to in accordance with an exemplary embodiment of the present invention;

FIG. 8f is a table diagram representing rate tiers to apply to in accordance with an exemplary embodiment of the present invention;

FIG. 9a is a table diagram representing data elements stored in, and relationships between data elements stored in, a payment file in accordance with a first exemplary embodiment of the present invention;

FIG. 9b is a table diagram representing data elements stored in, and relationships between data elements stored in, a payment file in accordance with a second exemplary embodiment of the present invention;

FIG. 9c is a table diagram representing data elements stored in, and relationships between data elements stored in, a payment file in accordance with a third exemplary embodiment of the present invention;

FIG. 10a is a ladder diagram representing a combination of data structures and instructions stored in memory and executed by a processor for making payments from each payer of a community of payers to each vendor of a community of vendors, assessing a variable transaction fee to each vendor, and providing a variable rebate to each payer, all in accordance with a first exemplary embodiment of the present invention;

FIG. 10b is a ladder diagram representing a combination of data structures and instructions stored in memory and executed by a processor for making payments from each payer of a community of payers to each vendor of a community of vendors, assessing a variable transaction fee to each vendor, and providing a variable rebate to each payer, all in accordance with a second exemplary embodiment of the present invention;

FIG. 10c is a ladder diagram representing a combination of data structures and instructions stored in memory and executed by a processor for making payments from each payer of a community of payers to each vendor of a community of vendors assessing a variable transaction fee to each vendor, and providing a variable rebate to each payer, all in accordance with a third exemplary embodiment of the present invention;

FIG. 10d is a ladder diagram representing a combination of data structures and instructions stored in memory and executed by a processor for making payments from each payer of a community of payers to each vendor of a community of vendors assessing a variable transaction fee to each vendor, and providing a variable rebate to each payer, all in accordance with a fourth exemplary embodiment of the present invention;

FIG. 11 is a flow chart representing exemplary instructions stored in memory and executed by a processor for determining a transaction fee to asses on a payment in accordance with an exemplary embodiment of the present invention; and

FIG. 12 is a flow chart representing rebate calculation in accordance with an exemplary embodiment of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code/instructions which is encoded within computer readable media accessible to the processor, or a combination of a hardware circuit(s) and a processor or control block of an integrated circuit executing machine readable code encoded within a computer readable media. As such, the term circuit, module, server, application, or other equivalent description of an element as used throughout this specification is intended to encompass a hardware circuit (whether discrete elements or an integrated circuit block), a processor or control block executing code encoded in a computer readable media, or a combination of a hardware circuit(s) and a processor and/or control block executing such code.

It should also be appreciated that table structures represented in this application are exemplary data structures only, of a non transitory nature embodied in computer readable memory, and intended to show the mapping of relationships between various data elements. Other table structures may store similar data elements in a manner that maintains the relationships useful for the practice of the present invention.

Within this application the applicant has depicted and described groups of certain elements. As used in this application, the term group (and the term community) means at least three of the elements. For example, a group of vendors means at least three vendors. When a group, for example a first group, is referred to as being distinct, or distinct from a second group, it means that the first group contains at least one element that is not present in the second group and the second group includes at least one element that is not present in the first group. The use of the term unique with respect to an element within a group or set of elements means that that the element is different then each other element in the set or group.

Within this application, the applicant has used the term database to describe a data structure which embodies groups of records or data elements stored in a volatile or non volatile storage medium and accessed by an application, which may be instructions coded to a storage medium and executed by a processor. The application may store and access the database.

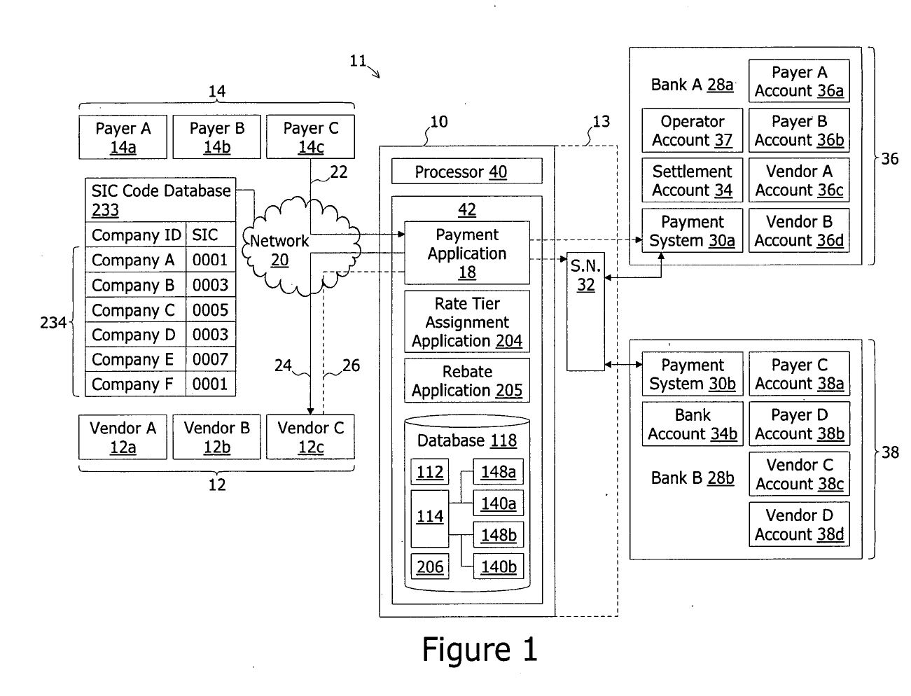

Turning to FIG. 1, an exemplary architecture 11 is shown in which a payment bureau 10 executes payments from each payer 14a, 14b, 14c of a community of payers 14 to each vendor 12a, 12b, 12c of a community of vendors 12, assessing a transaction fee to each vendor in conjunction with executing a payment from a payer to the vendor, and providing a variable rebate to the payer.

The transaction fee assessed to the vendor is based on a variable transaction rate. More specifically, the fee is the product of multiplying the amount of the payment by the rate that is applicable to payments made by the particular payer to the particular vendor. The rate is referred to as “variable” because: i) the rate is variable amongst vendors, the same payer may use different rates for different vendors; and ii) the rate is variable amongst payers, the same vendor may be subjected to different rates, based on the particular payer making the payment.

The system 10 is communicatively coupled to each payer 14a, 14b, 14c of the community of payers 14 and to each vendor 12a, 12b, 12c of the community of vendors 12 via an open network 20 such as the public internet.

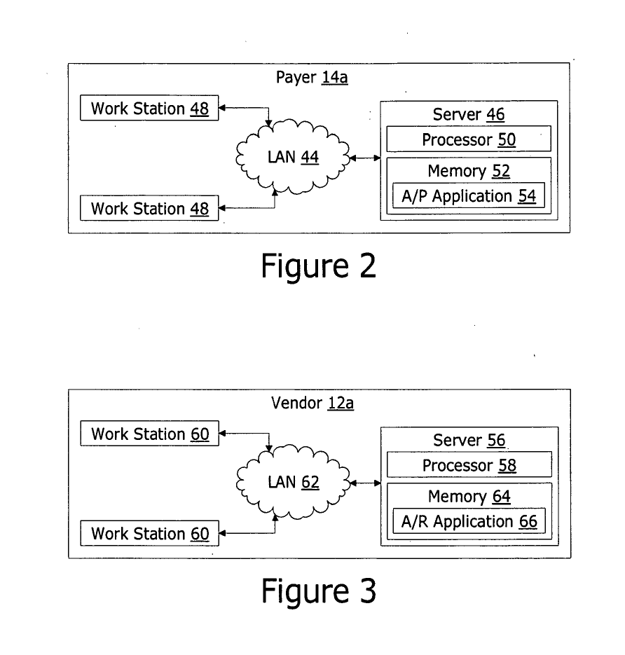

Turning briefly to FIG. 2 in conjunction with FIG. 1, in an exemplary embodiment, each payer, using payer 14a for example, may be a business that includes at least one computer system or server 46. The computer system(s) or server(s) 46 include at least one processor 50 and associated memory 52 programmed with an accounts payable application 54.

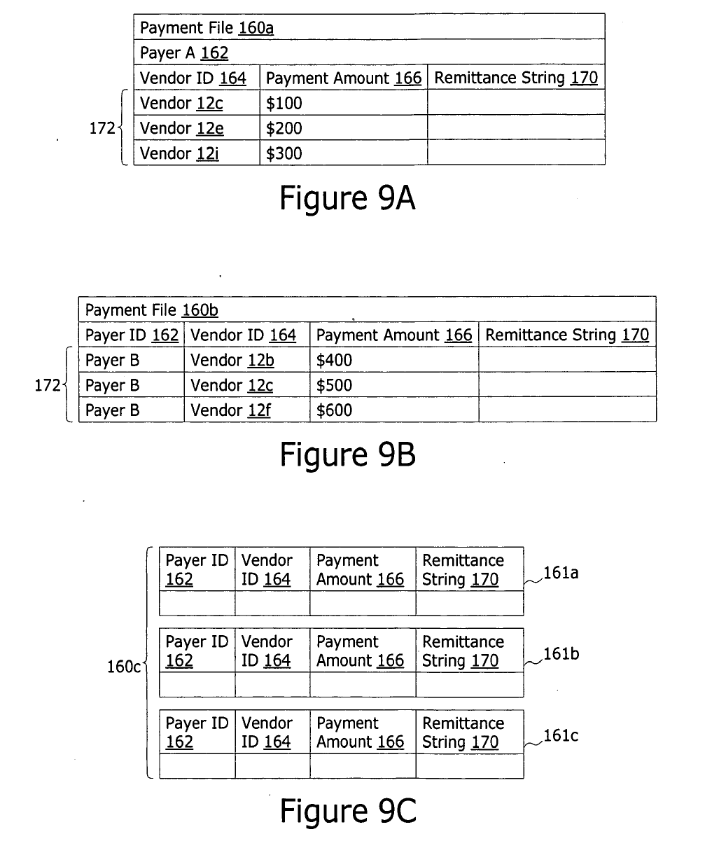

In a typical environment, the computer system(s) or server(s) 46 operating the accounts payable application 54 may be coupled to a local area network 44 and accessed by entitled users of workstations 48 and may be used for managing the payer's accounts payables and issuing payments to its vendors. The accounts payable application 54 may issue the payment instructions and/or payment files described with respect to FIGS. 9a, 9b, and 9c.

Turning briefly to FIG. 3 in conjunction with FIG. 1, in an exemplary embodiment, each vendor, using vendor 12a for example, may be a business that includes at least one computer system or server 56. The computer system(s) or server(s) 56 include at least one processor 58 and associated memory 64 programmed with an accounts receivable application 66.

In a typical environment, the computer system(s) or server(s) 56 operating the accounts receivable application 66 may be coupled to a local area network 62 and accessed by entitled users of workstations 60 and may be used for managing the vendor's accounts receivables and reconciling payments issued by customers (i.e. payers) against amounts due to the vendor.

Returning to FIG. 1, for purposes of illustrating the invention, at least two banks 28a and 28b are represented. Each bank, for example bank 28a, may include a payment system 30a (i.e. instructions coded to a computer readable medium and executed by a processor) which manages deposit accounts 36, including execution of credit and debit transactions to deposit accounts 36 in a traditional manner. Similarly bank 28b may include a payment system 30b (i.e. instructions coded to a computer readable medium and executed by a processor) which manages deposit accounts 38, including execution of credit and debit transactions to deposit accounts 38 in a traditional manner.

The payment system 30a, 30b of each bank 28a, 28b may further be coupled to a settlement network 32 which transfers funds between banks for settlement of payments between accounts a different banks. Exemplary settlement networks include the National Automated Clearing House Association (NACHA) for settling ACH transactions and the Federal Reserve for settling wire transactions. The settlement network may also be a card payment system operator such as American Express or a bank card brand provider—or an association, such as bank card brand providers Visa or MasterCard, which settles payments typically referred to as card payments.

Each bank may include, and each banks payment system 30a, 30b may also manage, multiple customer accounts 36 (for bank 28a) and 38 (for bank 28b). Each customer account is an account to which credit and debit transactions are posted representing credits and debits to the funds of a particular customer associated with the account (i.e. the account holder).

For example, bank 28a may have a customer account 36a for Payer 14a, a customer account 36b for payer 14b, a customer account 36c for vendor 12a, a customer account 36d for vendor 12b.

For example, bank 28b may have a customer account 38a for Payer 14c, a customer account 38b for payer 14d, a customer account 38c for vendor 12c, a customer account 38d for vendor 12d.

Each customer account for a payer may be a deposit account such as a commercial checking account. Each customer account for a vendor may be a deposit account such as a commercial checking account or a merchant services account such as an account funded upon settlement of a card payment transaction.

For purposes of illustrating this invention, bank 28a may further include, and the banks' payment system 30a may further manage, an operator account 37 which may be a deposit account, such as a commercial checking account, to which credits and debit transactions are posted representing credits and debits to funds of the operator of the system 10.

For purposes of illustrating this invention, bank 28a may further include, and the banks' payment system 30a may further manage, a settlement account 34 which may be a fiduciary consolidation account, such as a commercial checking account, to which credits and debit transactions are posted representing credits to fund payments to be issued by payers and debits to disburse payment to vendors.

In an exemplary embodiment, the payment bureau 10 may be communicatively coupled to at least one payment system of at least one bank, for example payment system 30a of bank 28a. This may be the payment system 30a which manages the operator account 37 and the settlement account(s) 34.

In another exemplary embodiment, the system 10 may further be coupled to the settlement network 32, or may alternatively be coupled to the settlement network 32 in lieu of being coupled to a payment system 30a of a bank 28a.

In yet another exemplary embodiment, the settlement network may be part of the payment bureau 10 as depicted by the dashed line 13 in FIG. 1. For example, if the payment bureau 10 is operated by a bank card association the payment bureau 10 may include a proprietary settlement network 32.

The payment bureau 10 may be a computer system of one or more servers comprising at least a processor 40 and computer readable medium 42. The computer readable media may include encoded thereon a payment application 18, a rate tier assignment application 204, a rebate application 205, and database 118. Each of the payment application 18 and rate tier assignment application 204 may be a computer program comprising instructions embodied on computer readable medium 42 and executed by the processor 40. The database 118 may include data structures, also referred to as tables, as described herein.

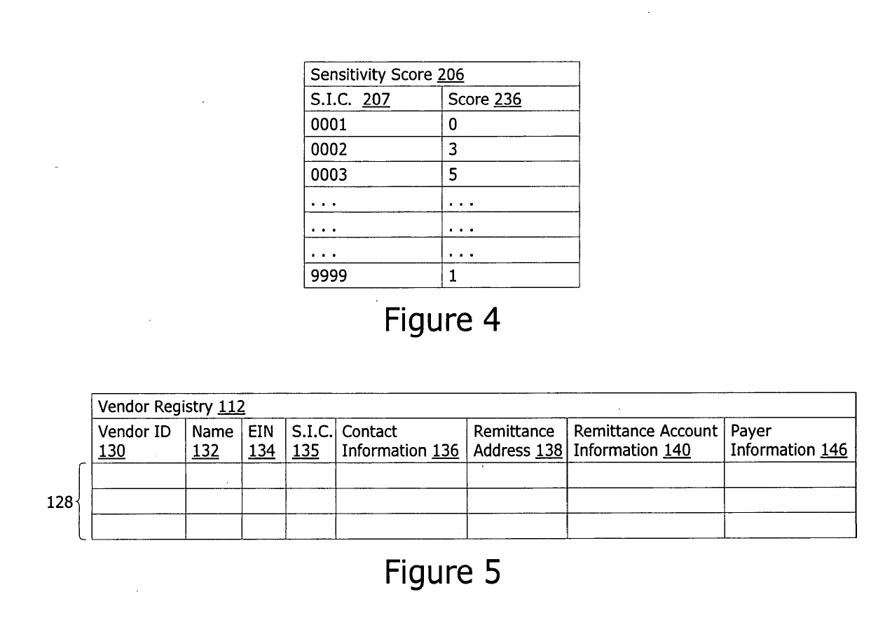

Referring to FIG. 4 in conjunction with FIG. 1, the database 118 may include, as one of its data structures, sensitivity score table 206. The sensitivity score table 206 may associate each industry code of a group of industry codes 207 to a sensitivity score 236. The group of industry codes 207 may be the four digit Standard Industrial Classification (SIC) code promulgated by the US Government; the six digit North American Industry Classification System (NAICS) code promulgated by the US Government, or the codes of any other industry classification system which utilizes alpha numeric characters or other code values to classify industries and commercial activities.

The sensitivity score 236 assigned to each industry code may be one of a group of discrete score values such as score values 1, 2, 3, 4, and 5 which represents how sensitive typical participants in such industry are to a fee charge related to receipt of payments. This measure or sensitivity may be determined based on evaluations of historical information related to industry participants accepting fees or other empirical evaluations or methods of study.

Turning briefly to FIG. 5 in conjunction with FIG. 1, the database 118 may further include, as one of the data structures, a vendor registry 112. The vendor registry 112 may comprise a group of vendor records 128. The group of vendor records 128 may comprise unique records, each of which is associated with, and identifies, a unique one of the vendors of the community of vendors 12 by inclusion of a unique vendor ID within a vendor ID field 130 of the record.

Also associated with the vendor may be: i) the vendors name included in a name field 132; ii) the vendor's tax identification number included in a tax ID field 134; iii) the vendor's industry code 135; iv) the vendor's contact information included in a contact information field 136; v) the vendors remittance address included in a remittance address field 138; and vi) the vendors remittance account information included in a remittance account information field 140.

The vendor's name 132 may be the official name of entity as recorded in official records of the jurisdiction in which it is formed and as used for titling its bank accounts, including its remittance account.

The vendor's industry code 135 may be the code of the group of industry codes 207 which represents the industry or commercial activity in which the vendor participates.

The vendor's remittance address 138 may be an address the vendor typically uses for receiving checks from its customers by regular mail (for example a lock box address).

The vendor's contact information 136 may include the name of an individual in the vendor's accounts receivable department responsible for managing the vendor's accounts receivable matters with the payers 22.

The vendor's remittance account information 140 may include bank account information (such as routing number and account number) and/or other information needed by the payment bureau to execute deposits to the vendor in accordance with payment authorization instructions provided by a payer.

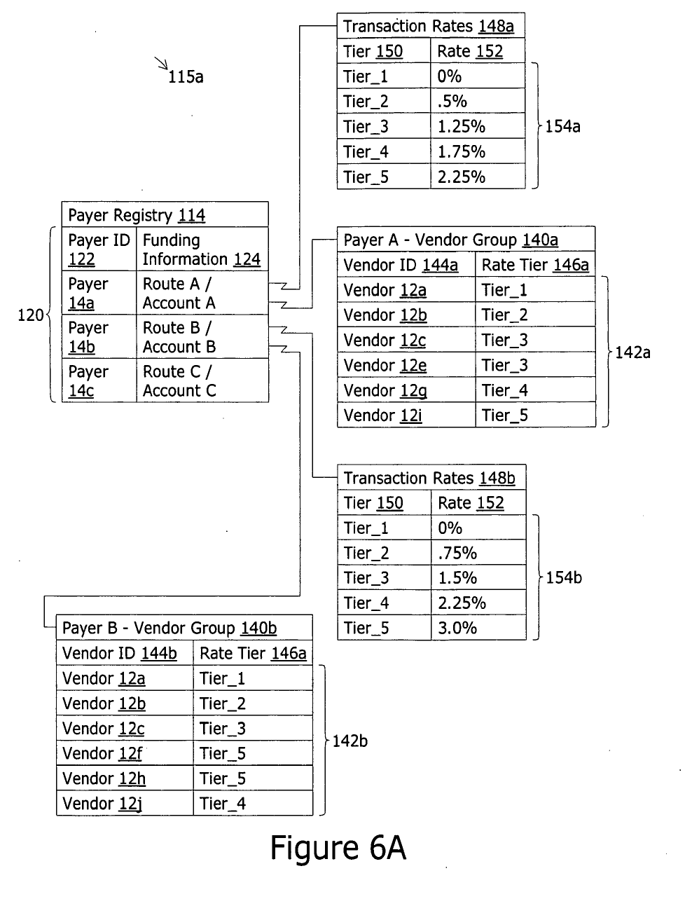

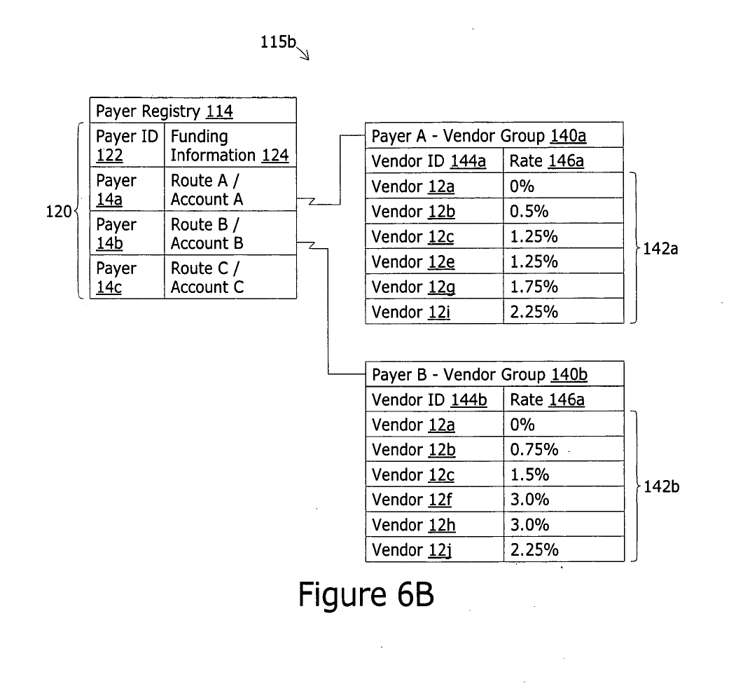

Turning to FIG. 6a in conjunction with FIG. 1, the database 118 may include, as one of the data structures, a data structure 115a which includes, for each payer 14a, 14b, 14c within the community of payers 14, identification of the payer and, in association with identification of the payer, identification of the payer's unique payer vendor subgroup, a rate tier associated with each vendor in the payer vendor subgroup, and payer specific transaction rates associate with each rate tier.

The payer's unique payer vendor subgroup is the group of vendors to which the payer makes payment using the payment bureau 10. The payer's payer vendor subgroup may be a subset of the community of vendors 12 that consists of fewer than the entire community of vendors and is distinct from each of the other payer's unique payer vendor subgroup.

More specifically, the data structure 115a may include a payer registry 114. The payer registry 114, may comprise a group of payer records 120. Each record 120 is associated with, and identifies a unique one of the payers 14a, 14b, 14c of the community of payers 14 by inclusion of a unique payer ID within a payer ID field 122 of the record.

Also associated with each payer is funding information unique to the payer and stored in at least one funding information field 124 of the record. The funding information may include bank account information (which may be a routing number and account number) identifying a bank deposit account belonging to the payer and/or other information used by the payment bureau 10 to execute payments from the account belonging to the payer to an account associated with a vendor within the payer's vendor subgroup in accordance with payment authorization instructions provided by the payer.

Each record of the payer registry 114 may be associated with a unique transaction rate table 148 and a unique payer vendor group table 140, for example the record for payer 14a (with payer ID “Payer A”) may be associated with transaction rate table 148a and payer vendor group table 140a and the record for payer 14b (with payer ID “Payer B”) may be associated with transaction rate table 148b and payer vendor group table 140b.

The transaction rate table 148a may include a group of records 154a. Each record may associate a unique transaction rate tier identifier (within a transaction rate tier field 150) with a unique transaction rate (within a transaction rate field 152) which may be a percentage of the amount of the transaction.

Payer vendor group table 140a, associated with payer 14a, may include identification of payer 14a, and a vendor ID for each vendor in Payer 14a's unique payer vendor subgroup. More specifically, the payer vendor group table 140a may include a group of records 142a with each record being unique to one of the vendor's within payer 14a's payer vendor subgroup.

Each record 142a may include a vendor ID within a vendor ID field 144a which identifies the vendor and associates the record with the vendor. For example, payer 14a's payer vendor subgroup may consists of six (6) vendors, vendor 12a, vendor 12b, vendor 12c, vendor 12e, vendor 12g, and vendor 12i, which is fewer then all vendors within the community of vendors 12.

The payer vendor group table 140a also associates each vendor with a transaction rate tier identifier used to determine a transaction rate that applies to payments from Payer 14a to the vendor. More specifically, a transaction rate tier identifier (corresponding to one of the transaction rate tier identifiers from a record of the transaction rates table 148a) may be within a transaction rate tier field 146a of the record 142a associated with the vendor.

For example, identification of first transaction rate tier (Tier_1) is associated with identification of Vendor 12a indicating that a first transaction rate applies to payments from Payer 14a to Vendor 12a. A second transaction rate tier (Tier_2) is associated with identification of Vendor 12b, a third transaction rate tier (Tier_3) is associated with identification of Vendor 12c, and Vendor 12e, a fourth transaction rate tier (Tier_4) is associated with identification of Vendor 12g, and a fifth transaction rate tier (Tier_6) is associated with identification of vendor 12i.

With respect to payer 14b, the transaction rate table 148b may include a group of records 154. Each record may associate a unique transaction rate tier identifier (within a transaction rate tier field 150) with a unique transaction rate (within a transaction rate field 152). Note that the transaction rates associated with each Tier 1-5 in table 148b (applicable to payments made by payer 14b) may be distinct from the transaction rates associated with the corresponding tier on table 148a (applicable to payments made by payer 14a).

Payer 14b's payer vendor subgroup may consists of six (6) vendors, vendor 12a, vendor 12b, vendor 12c, vendor 12f, vendor 12h, and vendor 12j, which is fewer then all vendors within the community of vendors 12. Within the vendor group table 140b, each of such vendors is associated with a unique record that includes the Vendor ID within the vendor ID field 144b.

The payer vendor group table 140b also associates each vendor with a transaction rate tier that applies to payments from Payer 14b to the vendor. More specifically, a transaction rate tier identifier (corresponding to one of the transaction rate tier identifiers from a record of the transaction rates table 148b) may be within a transaction rate tier field 146b of the record 142b associated with the vendor.

For example, identification of first transaction rate tier (Tier_1) is associated with identification of Vendor 12a indicating that a first transaction rate applies to payments from Payer 14b to Vendor 12a, a second transaction rate tier (Tier_2) is associated with identification of Vendor 12b, a third transaction rate tier (Tier_3) is associated with identification of Vendor 12c, the fourth transaction rate tier (Tier_5) is associated with identification of Vendor 12f and Vendor 12h, and a fifth transaction rate tier (Tier_4) is associated with identification of vendor 12j.

It should be appreciated that, within each payer's payer vendor subgroup, each vendor in each subgroup is different from each vendor in each other subgroup. Stated another way, no vendor is within multiple subgroups of any payer's payer vendor subgroup.

Turning to FIG. 6b, in conjunction with FIG. 1, an alternative data structure 115b is represented. Data structure 115b includes, for each payer 14a, 14b, 14c within the community of payers 14, identification of the payer and, in association with identification of the payer, identification of the payer's unique payer vendor subgroup, and a payer specific transaction rate to associate with each vendor in the payer vendor subgroup.

More specifically, the data structure 115b may include a payer registry 114. The payer registry 114, may comprise a group of payer records 120. Each record 120 is associated with, and identifies a unique one of the payers 14a, 14b, 14c of the community of payers 14 by inclusion of a unique payer ID within a payer ID field 122 of the record.

Also associated with each payer is funding information unique to the payer and stored in at least one funding information field 124 of the record. The funding information may include bank account information (which may be a routing number and account number) identifying a bank deposit account belonging to the payer and/or other information used by the payment bureau 10 to execute payments from the account belonging to the payer to an account associated with a vendor within the payer's vendor subgroup in accordance with payment authorization instructions provided by the payer.

Each record of the payer registry 114 may be associated with a unique payer vendor group table 140, for example the record for payer 14a (with payer ID “Payer A”) may be associated with payer vendor group table 140a and the record for payer 14b (with payer ID “Payer B”) may be associated with payer vendor group table 140b.

Payer vendor group table 140a, associated with payer 14a, may include identification of payer 14a, and a vendor ID for each vendor in Payer 14a's unique payer vendor subgroup. More specifically, the payer vendor group table 140a may include a group of records 142a with each record being unique to one of the vendor's within payer 14a's payer vendor subgroup.

Each record 142a may include a vendor ID within a vendor ID field 144a which identifies the vendor and associates the record with the vendor. For example, payer 14a's payer vendor subgroup may consists of six (6) vendors, vendor 12a, vendor 12b, vendor 12c, vendor 12e, vendor 12g, and vendor 12i, which is fewer then all vendors within the community of vendors 12.

The payer vendor group table 140a also associates each vendor with a transaction rate that applies to payments from Payer 14a to the vendor. More specifically, a transaction rate may be specified as a percentage or fractional value within a transaction rate field 146a of the record 142a associated with the vendor.

For example, identification of zero percent (0.00%) is associated with identification of Vendor 12a indicating that a transaction rate of zero percent (0.00%) applies to payments from Payer 14a to Vendor 12a. A transaction rate of one half percent (0.50%) is associated with identification of Vendor 12b, a transaction rate of one and one quarter percent (1.25%) is associated with identification of Vendor 12c, and Vendor 12e, a transaction rate of one and three quarters percent (1.75%) is associated with identification of Vendor 12g, and a transaction rate of two and one quarter percent (2.25%) is associated with identification of vendor 12i.

Payer 14b's payer vendor subgroup may consists of six (6) vendors, vendor 12a, vendor 12b, vendor 12c, vendor 12f, vendor 12h, and vendor 12j, which is fewer then all vendors within the community of vendors 12. Within the vendor group table 140b, each of such vendors is associated with a unique record that includes the Vendor ID within the vendor ID field 144b.

The payer vendor group table 140b also associates each vendor with a transaction rate that applies to payments from Payer 14b to the vendor. More specifically, a transaction rate may be specified as a percentage or fractional value within a transaction rate field 146b of the record 142b associated with the vendor.

For example, identification of a transaction rate of zero (0.00%) is associated with identification of Vendor 12a, a transaction rate of three quarters of a percent (0.75%) is associated with identification of Vendor 12b, a transaction rate of one and one half percent (1.50%) is associated with identification of Vendor 12c, a transaction rate of three percent (3.00%) is associated with identification of Vendor 12f and Vendor 12h, and a transaction rate of two and one quarter percent (2.25%) is associated with identification of vendor 12j.

In both the data structure embodiment described with respect to FIG. 6a and the data structure embodiment describe with respect to FIG. 6b, an initial transaction rate (or rate tier) may be assigned to each vendor by the rate tier assignment application 204 (FIG. 1).

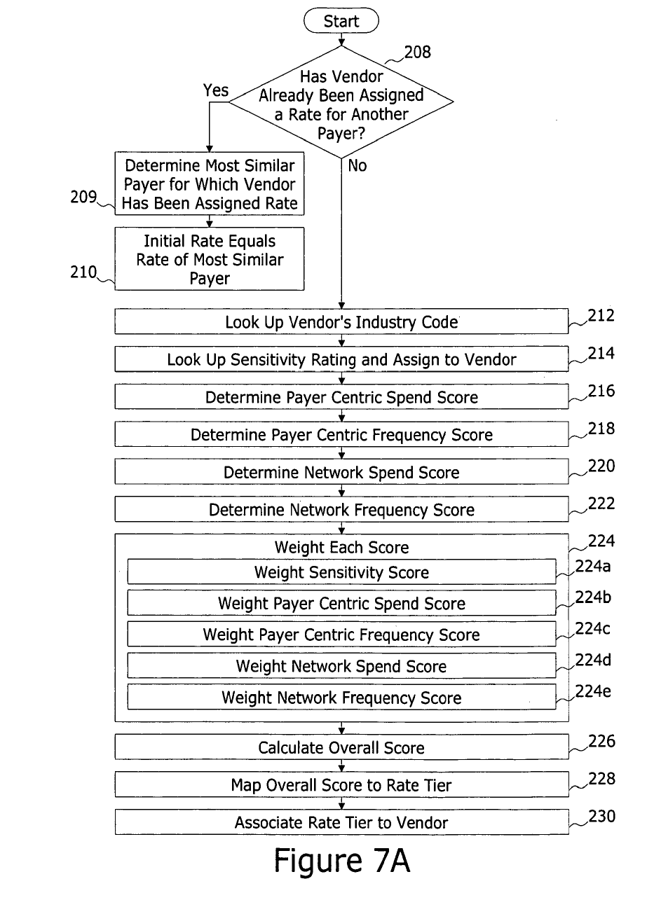

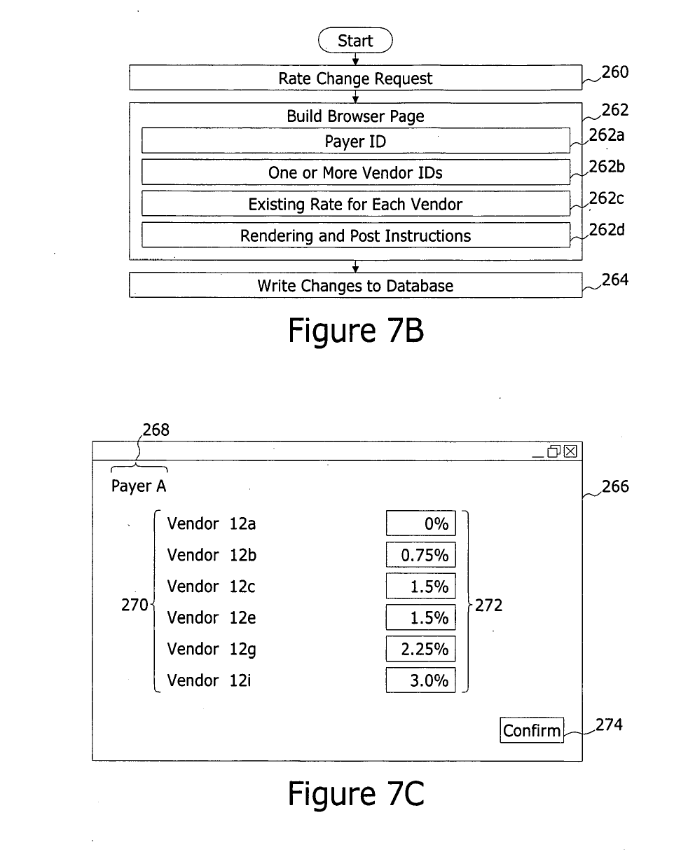

Turning to FIG. 7a, exemplary steps performed by the rate tier assignment application 204 to assign, for a prospective payer, an initial payer specific rate to a vendor are shown. Step 208 represents determining whether the vendor has already been assigned a rate by another payer. If the vendor has already been assigned a rate by one or more other payers, the rate tier assignment application 204 determines which of the one or more other payers has the most similar payer/vendor relationship with the vendor as the prospective payer.

More specifically, if the vendor has an assigned rate for only one other payer, that one payer would be the payer with the most similar payer/vendor relationship. If the vendor has an assigned rate with more than one payer, the other payer which pays the vendor the most similar annual payment volume and the most similar payment frequency would be the payer with the most similar payer/vendor relationship.

At step 210, the rate assigned to the vendor, for payments by the prospective payer, would be the same rate that is in effect with the most similar other payer.

Alternatively, if at step 208 it is determined that the vendor has not already been assigned a rate for payments by any other payers, the rate assignment application 204 executes steps 212 through 230 to assign an initial rate.

Step 212 represents determining the vendor's industry code. The rate tier assignment application 204 may determine the vendor's industry code by retrieving it from the industry code field 135 of the record associated with the vendor in the vendor registry 112 (FIG. 5). Alternatively, with reference to FIG. 1 in conjunction with FIG. 5, if the vendor's industry code is not available in the vendor registry 112, the rate tier assignment application 204 may query a SIC code database 232.

The SIC code database 232 may associate the name of each company within a group of companies 234 with the company's industry code. Each company may be identified by its name; tax ID number, or other identifier. In querying the SIC code database 232, the rate tier assignment application may provide the vendor's name, tax ID number, or other identifier and receive, in response, the vendors industry code.

The SIC database 233 may be a remote database accessible over the internet 20 as depicted in FIG. 1, a local database coupled to the system 10, or a local database that is part of database 118 of system 10.

Returning to FIG. 7a, step 214 represents determining the vendor's industry sensitivity score by looking up the industry sensitivity score 236 associated with the vendor's industry code in the sensitivity score table 206 (FIG. 4).

Step 216 represents determining the vendor's payer centric spend score. The vendor's payer centric spend score is a function of the aggregate value of all payments expected to be made by a particular payer, for example payer 14a, to the vendor over a predetermined period of time, such as one calendar year and may be an integer value of one (1) through five (5).

The aggregate amount of payments expected to be made by the particular payer to the vendor over the one year period may be determined based on historical payment information, such as the aggregate amount of payments made by the particular payer to the vendor over the previous year.

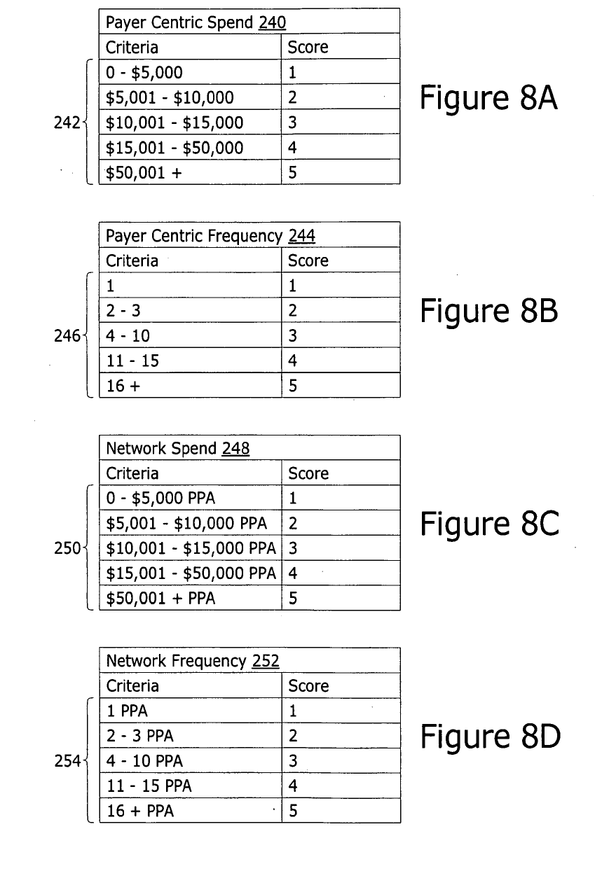

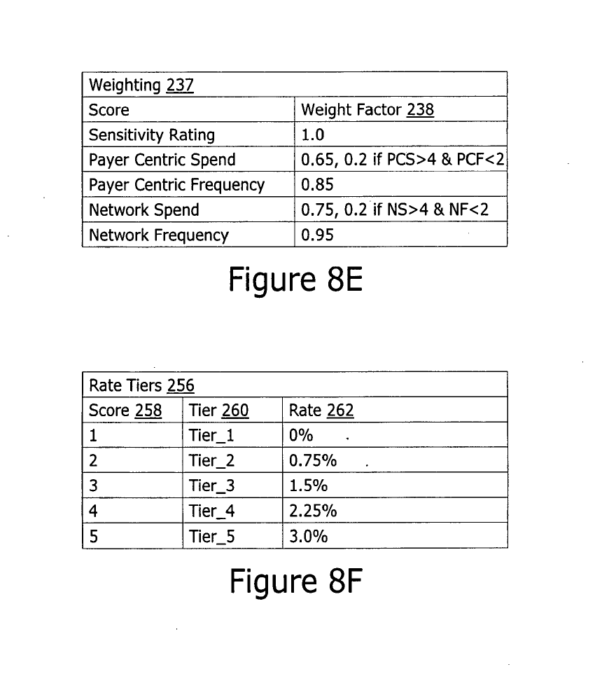

Referring briefly to FIG. 8a in conjunction with FIG. 1, in an exemplary embodiment, the rate tier assignment application 204 may maintain a payer centric spend table 240 (which may be embodied in computer readable memory) which includes a record 242 associated with each score value 1-5. The record designates criteria for assigning the score value. In the exemplary embodiment: i) a score value of 1 is assigned if the aggregate amount of payments expected to be made by the particular payer to the vendor over a one year period is less than or equal to $5,000; ii) a score value of 2 is assigned if the aggregate amount of payments expected to be made by the particular payer to the vendor over a one year period is between $5,001 and $10,000; iii) a score value of 3 is assigned if the aggregate amount of payments expected to be made by the particular payer to the vendor over a one year period is between $10,001 and $15,000; iv) a score value of 4 is assigned if the aggregate amount of payments expected to be made by the particular payer to the vendor over a one year period is between $15,001 and $50,000; and v) a score value of 5 is assigned if the aggregate amount of payments expected to be made by the particular payer to the vendor over a one year period is greater than $50,000.

Step 218 represents determining the vendor's payer centric frequency score. The vendor's payer centric frequency score is a function of the quantity of payments expected to be made by a particular payer, for example payer 14a, to the vendor over a predetermined period of time, such as one calendar year and may be may be an integer value of one (1) through five (5).

The total quantity of payments expected to be made by the particular payer to the vendor over the one year period may be determined based on historical payment information, such as the total quantity of payments made by the particular payer to the vendor over the previous year.

Referring briefly to FIG. 8b in conjunction with FIG. 1, in an exemplary embodiment, the rate tier assignment application 204 may maintain a payer centric frequency table 244 (embodied in computer readable memory) which includes a record 246 associated with each score value 1-5. The record designates criteria for assigning the score value. In the exemplary embodiment: i) a score value of 1 is assigned if the total quantity of payments expected to be made by the particular payer to the vendor over a one year period is no greater than one (1); ii) a score value of 2 is assigned if the total quantity of payments expected to be made by the particular payer to the vendor over a one year period is two (2) to three (3); iii) a score value of 3 is assigned if the total quantity of payments expected to be made by the particular payer to the vendor over a one year period is between four (4) and ten (10); iv) a score value of 4 is assigned if the total quantity of payments expected to be made by the particular payer to the vendor over a one year period is between eleven (11) and fifteen (15); and v) a score value of 5 is assigned if the total quantity of payments expected to be made by the particular payer to the vendor over a one year period is greater than fifteen (15).

Step 220 represents determining the vendor's network spend score. The vendor's network spend score is a function of the aggregate value of all payments expected to be made by all payers within the group of payers 14 to the vendor over a predetermined period of time, such as one calendar year and may be may be an integer value of one (1) through five (5).

The aggregate amount of payments expected to be made to the vendor by multiple payers within the network of payers over the one year period may be determined based on historical payment information, such as the aggregate amount of payments made to the vendor by multiple payers within the network of payers over the previous year.

Referring briefly to FIG. 8c in conjunction with FIG. 1, in an exemplary embodiment, the rate tier assignment application 204 may maintain a network spend table 248 (embodied in computer readable memory) which includes a record 250 associated with each score value 1-5. The record designates criteria for assigning the score value. In the exemplary embodiment: i) a score value of 1 is assigned if the aggregate amount of payments expected to be made to the vendor by multiple payers within the network of payers over a one year period; divided by the number of payers making payment to the vendor to derive a “per payer average” results in a per payer average less than or equal to $5,000; ii) a score value of 2 is assigned if the aggregate amount of payments expected to be made to the vendor by multiple payers within the network of payers over a one year period results in a per payer average between $5,001 and $10,000; iii) a score value of 3 is assigned if the aggregate amount of payments expected to be made to the vendor by multiple payers within the network of payers over a one year period results in a per payer average between $10,001 and $15,000; iv) a score value of 4 is assigned if the aggregate amount of payments expected to be made to the vendor by multiple payers within the network of payers over a one year period results in a per payer average between $15,001 and $50,000; and v) is assigned if the aggregate amount of payments expected to be made to the vendor by multiple payers within the network of payers over a one year period results in a per payer average greater than $50,000.

Step 222 represents determining the vendor's network centric frequency score. The vendor's network frequency score is a function of the totally quantity of payments expected to be made by all payers within the group of payers 14 to the vendor over a predetermined period of time, such as one calendar year and may be may be an integer value of one (1) through five (5).

The total quantity of payments expected to be made to the vendor by multiple payers within the network of payers over the one year period may be determined based on historical payment information, such as the total quantity of payments made to the vendor by multiple payers within the network of payers over the previous year.

Referring briefly to FIG. 8d in conjunction with FIG. 1, in an exemplary embodiment, the rate tier assignment application 204 may maintain a network frequency table 252 (embodied in computer readable memory) which includes a record 254 associated with each score value 1-5. The record designates criteria for assigning the score value. In the exemplary embodiment: i) a score value of 1 is assigned if the total quantity of payments expected to be made to the vendor by multiple payers within the network of payers; divided by the number of payers making payment to the vendor to result in a “per payer average” results in a per payer average of one (1); ii) a score value of 2 is assigned if the total quantity of payments expected to be made to the vendor by multiple payers within the network of payers results in a per payer average of two (2) to three (3); iii) a score value of 3 is assigned if the total quantity of payments expected to be made to the vendor by multiple payers within the network of payers results in a per payer average of four (4) and ten (10); iv) a score value of 4 is assigned if the total quantity of payments expected to be made to the vendor by multiple payers within the network of payers results in a per payer average of eleven (11) and fifteen (15); and v) a score value of 5 is assigned if the total quantity of payments expected to be made to the vendor by multiple payers within the network of payers results in a per payer average of sixteen (16) or greater. In all cases fractional values may be rounded to the nearest integer value, rounded up to the nearest integer value, or rounded down (i.e. truncated) to the nearest integer value.

Returning to FIG. 7a, step 224 represents weighting each score. Referring to the weighting table of FIG. 8e, each score, as determined at steps 214 through 222 is multiplied by a weight factor 238 to determine a weighted score.

More particularly, at step 224a, the sensitivity score is weighted (or multiplied by) a factor of 1.0 to determine a weighted industry sensitivity score.

At step 224b the payer centric spend score is weighted by a factor of 0.65 to determine a weighted payer centric spend score. Provided however, in the event the payer centric spend score is greater than four (4) and the payer centric frequency score is less than two (2), the payer centric spend score is weighted by a factor of 0.2 to determine the weighted payer centric spend score.

At step 224c the payer centric frequency score is weighted by a factor of 0.85 to determine a weighted payer centric frequency score.

At step 224d the network spend score is weighted by a factor of 0.75 to determine a weighted network spend score. Provided however, in the event the network spend score is greater than four (4) and the network frequency score is less than two (2), the network spend score is weighted by a factor of 0.2 to determine the weighted network spend score.

At step 224e the network frequency score is weighted by a factor of 0.95 to determine a weighted network frequency score.

Step 226 represents calculating an overall score. The overall score is the average of the weighted industry sensitivity score, the weighted payer centric spend score, the weighted payer centric frequency score, the weighted network spend score, and the weighted network frequency score. It should be appreciated that each weight factor associated with each score may be distinct from other weight factors associated with other scores.

Step 228 represents determining the rate to initially assign to the vendor by mapping the overall score to a rate tier. Referring to FIG. 8F, examples of how the mapping may be performed include: i) rounding the overall score to the closest rate tier score value 258, for example overall score of 2.51 maps to rate Tier_3; and ii) truncating the overall score to the closest rate tier value, for example overall score of 2.51 maps to rate Tier_2.

Step 230 represents associating the rate tier with the vendor by: i) writing the rate tier 260 (if the embodiment described in FIG. 6a is implemented) in association with the vendor in the payer vendor subgroup table 140 associated with the payer that was used for determining the payer centric spend score and the payer centric frequency score; or ii) writing the percentage rate 262 of the rate tier (if the embodiment described in FIG. 6b is implemented) in association with the vendor in the payer vendor subgroup table 140 associated with the payer that was used for determining the payer centric spend score and the payer centric frequency score.

It should be appreciated that the steps represented by FIG. 7a represent the exemplary embodiment wherein the overall score and the rate tier assigned to the vendor are a function of all of the vendor's industry score, payer centric spend score, payer centric frequency score, network spend score, and network frequency score. The scope of the present invention includes determining the overall score and rate tier assignment as a function of permutations of one or more of any of these scores.

For example, determining the rate tier based on: i) industry score only (permutation of only one score), ii) industry score, payer centric spend score, and payer centric frequency score (permutation of three scores); and iii) industry score, network spend score, and network frequency score (a different permutation of three scores). When permutations of fewer than all scores are used, the weighted average is based on only those scores that are used.

Turning to FIG. 7b, the rate tier assignment application 204 further includes steps which, when executed by the processor permit a rate assigned to a vendor (for a prospective payer) to be altered by, or at the direction of, the prospective payer.

Step 260 represents a rate change request being provided to the rate tier assignment application 204. In response, the rate tier assignment application 204 builds a browser page which permits the rate to be altered. FIG. 7c depicts an exemplary browser page 266, in graphic form. Referring to FIG. 7b and FIG. 7c, step 262 represents populating the payer ID 268 of the prospective payer to the browser page 266. Step 262b represents populating one or more vendor IDs 270 to the browser page 266, each vendor ID being for a vendor within the prospective payer's payer vendor group. Step 262c represents populating the existing rate 272 applicable to each such vendor (for payments from the prospective payer) as such rates are recorded in the data structure 115 depicted in FIGS. 6a and 6b. Step 262d represents populating rendering instructions to the browser page, the rendering instructions may be the code necessary for a browser executing on a remote computer to render the browser page 266 in graphic format and post user entered changes to the existing rate 272 back from the remote computer to the rate assignment application 204 in response to user action such as clicking a confirm button 274. Upon receipt of such a post, the rate assignment application 204 writes, at step 263, the updated rates to the applicable fields of the data structure 115 (FIG. 6a, FIG. 6b).

Turning to FIG. 1, in operation, the payment bureau 10 processes payments, each payment being initiated by one of the payer's within the community of payers 14, for payment of a payment amount from the payer's account to one of the vendors within the community of vendors 12. More specifically, from each payer 14a, 14b, 14c of the community of payers 14, the payment bureau 10 receives a payment instruction file identifying payments to process for the payer. For example, arrow 22 represents receipt of a payment instruction file from payer 14c identifying payments to process for payer 14c, the payments being payments to a group of vendor's within the payer 14a's payer vendor subgroup.

Referring to FIG. 9a a first exemplary payment instruction data structure, or payment instruction file is depicted. Referring to FIG. 1 in conjunction with FIG. 9a, the payment file 160a may comprises identification of the payer within a payer ID field 162 (Payer ID “Payer A” representing payer 14a) and, associated with that payer ID field 152, a group of unique records 172, each record representing a unique payment instruction. Each record 172 includes: i) identification of the vendor to which payment is to be made by inclusion of the vendor's Vendor ID (from the vendor registry 112) within a vendor ID field 164; ii) identification of the amount of the payment to be made to the vendor by inclusion of a payment amount within a payment amount field 166; and iii) remittance information, which may be alpha numeric information identifying what payable is being paid, within a remittance string field 170. The remittance information may identify the vendor's invoice being paid, goods or services for which payment is being made, or other aspects of an underlying transaction between the payer and vendor giving rise to the payment associated with the record.

FIG. 9b represents a second exemplary payment instruction data structure, or payment instruction file. Referring to FIG. 1 in conjunction with FIG. 9b, the payment file 160b may comprise a group of unique records 172, each record representing a unique payment instruction. Each record 172 includes: i) identification of the payer within a payer ID record 162 (i.e. Payer ID “Payer B” representing payer 14b)); ii) identification of the vendor to which payment is to be made by inclusion of the vendor's Vendor ID (from the vendor registry 112) within a vendor ID field 164; iii) identification of the amount of the payment to be made to the vendor by inclusion of a payment amount within a payment amount field 166; and iv) remittance information, which may be alpha numeric information identifying what payable is being paid, within a remittance string field 170. Again, the remittance information may identify the vendor's invoice being paid, goods or services for which payment is being made, or other aspects of an underlying transaction between the payer and vendor giving rise to the payment associated with the record.

FIG. 9c represents a third exemplary payment instruction data structure, or payment instruction file. Referring to FIG. 1 in conjunction with FIG. 9c, a group of independent payment instructions, comprising unique payment instructions 161a, 161b and 161c, may in the aggregate be a payment instruction file 160c.

Each payment instruction may include: i) identification of the payer within a payer ID record 162; ii) identification of the vendor to which payment is to be made by inclusion of the vendor's Vendor ID (from the vendor registry 112) within a vendor ID field 164; iii) identification of the amount of the payment to be made to the vendor by inclusion of a payment amount within a payment amount field 166; and iv) remittance information, which may be alpha numeric information identifying what payable is being paid, within a remittance string field 170. Again, the remittance information may identify the vendor's invoice being paid, goods or services for which payment is being made, or other aspects of an underlying transaction between the payer and vendor giving rise to the payment associated with the record.

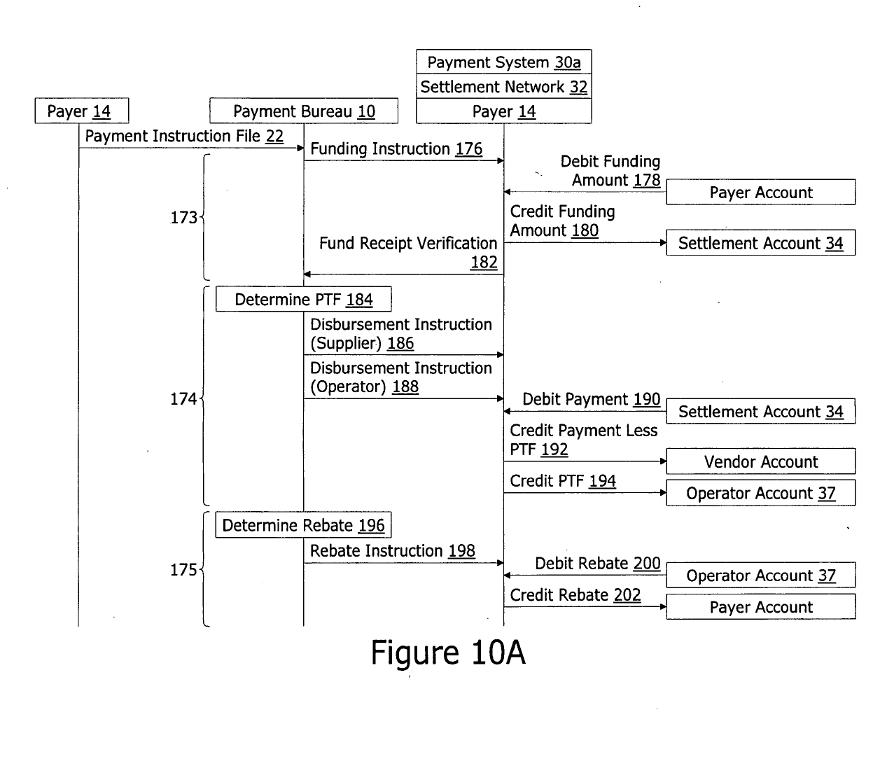

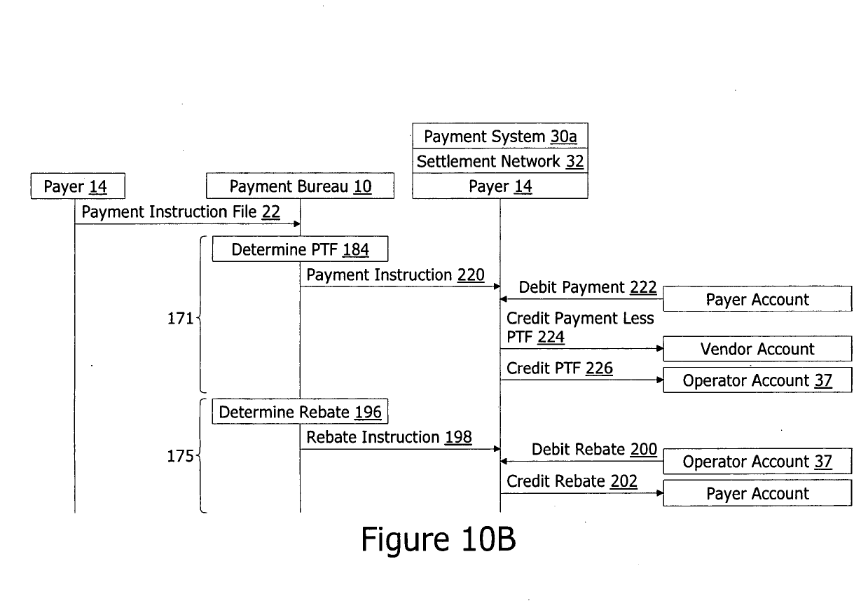

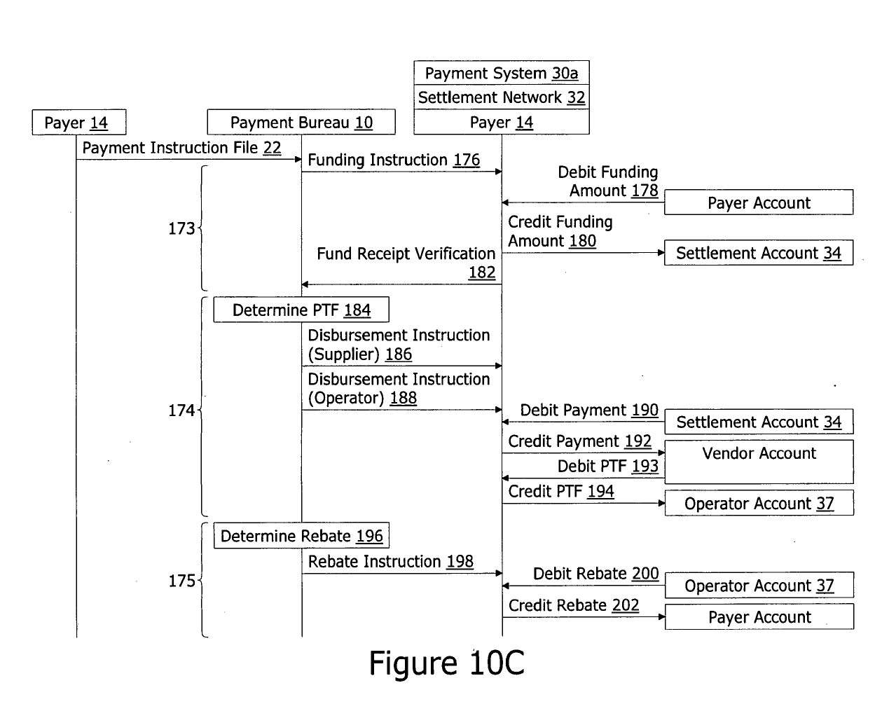

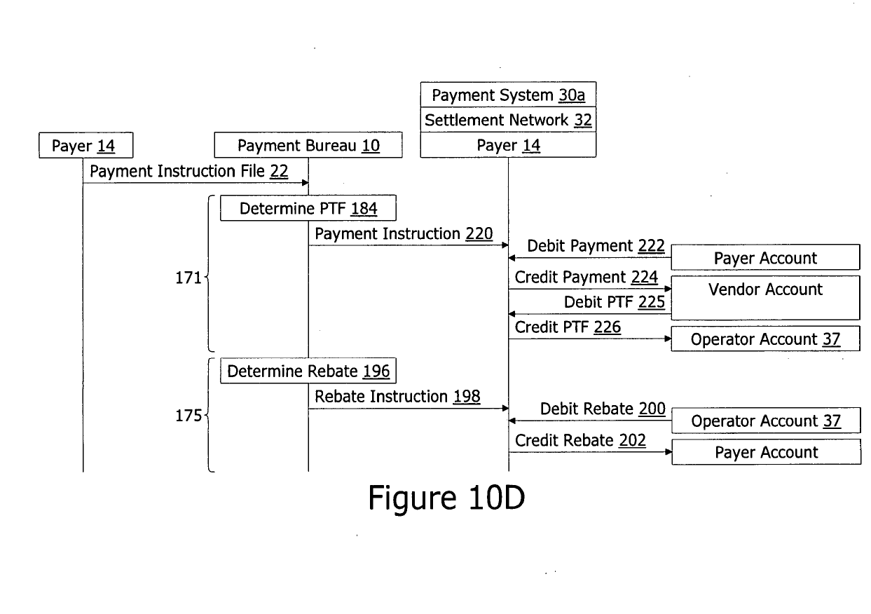

Referring to the ladder diagram of FIG. 10a in conjunction with FIG. 1, in an exemplary embodiment of operation, the payment bureau 10 receives a payment file, for example payment file 160a (FIG. 9a) from payer 14a, as represented by step 22. The payment instruction file may be transferred via a secure connection over the network 20 which may include implementing encryption of the connection and/or the file transferred over the connection.

Upon receiving and authenticating the payment file 160, the payment bureau 10, or more specifically, the processor 40 executing the payment application 18, performs funding steps 173 to transfer a funding amount equal to the aggregate or sum of the amount of all payments in the payment file 160 from the payer's account (account 36a at bank 28a) to the settlement account 34.

The funding steps 173 may include generating a funding instruction 176 to the payment system 30a to which the payment bureau 10 is coupled. The funding instruction 176 may include initiation of a debit transaction to debit the funding amount from the payer's transaction account (account 36a) as represented by step 178 and a credit transaction to credit to the settlement account 34 the funding amount as represented by step 180. The funding steps 173 may further include the payment system 30a providing a message back to the payment bureau verifying that the funding amount has been received in the settlement account 34.

The debit of the payer's account and credit to the settlement account may be by funds transfer if both accounts are held at the same bank, by transfer through a settlement network 32 (for example via ACH or Wire) if the payers account and settlement account are held at different banks.

In a second funding embodiment, the funding instruction 176 may be an instruction, or a debit/credit instruction pair, sent directly by the payment application 18 to the settlement network 32 to effect the initiation of a debit transaction to debit the funding amount from payer's account (account 36a) as represented by step 178 and initiation of a credit transaction to credit to the settlement account 34 the funding amount as represented by step 180.

As discussed, the settlement network 32 may be separate from the payment bureau 10, such as the Fedwire settlement network or the ACH settlement network, or may be a proprietary component of the payment bureau 10, such as a bank card association settlement network. In an embodiment wherein the settlement network 32 is part of the payment bureau 10, the settlement network 32 may be an application comprising instructions stored on the computer readable medium 42 and executed by processor 40, such instructions implementing the credit and debit transactions as described in this specification.

In a third funding embodiment, the funding instruction 176 may be a message to the payer from which the payment file was received. The payer may then, accessing a payment system 30 at the payer's bank or a settlement network, initiate a debit transaction to debit the funding amount from payers account (account 36a) as represented by step 178 and initiation of a credit transaction to credit to the settlement account 34 the funding amount as represented by step 180. The message to the payer may simple be a message acknowledging receipt of the payment file.

In both the second funding embodiment and the third funding, the verification of receipt of the funding amount in the settlement account 34 may be a message to the payment bureau 10 that is generated by the bank at which the settlement account 34 is held.

After the funding amount is received in the settlement account 34, disbursement steps 174 are performed for each payment represented in the payment file. In executing the disbursement steps 174 for a payment, the payment bureau 10 identifies a payment transaction fee to apply to the payment at step 184.

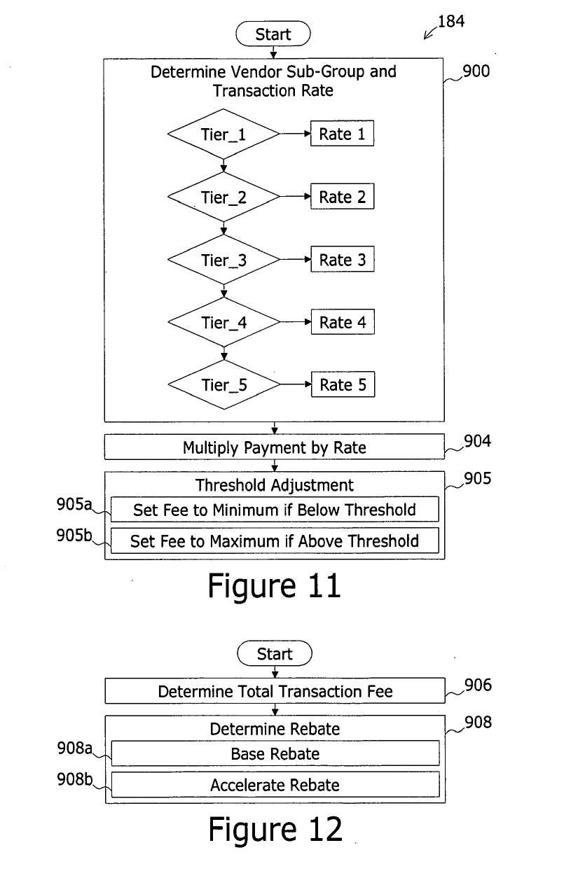

Turning briefly to flow chart of FIG. 11, in conjunction with FIG. 6a for a first example, identifying the payment transaction fee to apply to a payment may comprise, as represented by step 900, looking up, in the database 118, the subgroup of the payer's payer vendor subgroup to which the vendor is a member.

For example, the first payment represented in payment file 160a, represents a payment of $100 from payer 14a to vendor 12c. In this example, the payment bureau 10, at step 900, looks up in the payer vendor group table 140a associated with payer 14a, the transaction rate group identified in the record associated with vendor 12c (i.e. Tier_3) to determine the transaction rate group in which the vendor belongs and looks up, in the transaction rate table 148a, the transaction rate applicable to Tier _3. This process effectively distinguishes whether the vendor 12c is a member of a first subgroup, second subgroup, third subgroup, fourth subgroup, or fifth subgroup of the payer 14a's payer vendor group.

Turning briefly to flow chart of FIG. 11, in conjunction with FIG. 6b for a second example, again for the first payment represented in payment file 160a, step 900 represents the payment bureau 10 looking up in the payer vendor group table 140a associated with payer 14a, the transaction rate identified in the record associated with vendor 12c (1.25%).

In either embodiment, step 904 represents determining the payment transaction fee by multiplying the amount of the payment (i.e. $100 in the example) by the applicable transaction rate (1.25%) to yield the payment transaction fee (i.e. $1.25 in the example).

Step 905 represents making a threshold adjustment to the transaction fee determined at step 904 in the event the transaction fee, as determined at step 904, is below a minimum threshold or above a maximum threshold.

Sub-step 905a represents setting the transaction fee to a predetermined minimum transaction fee in the event the transaction fee, as determined at step 904 is below a threshold equal to the minimum transaction fee. For example, if the predetermined minimum transaction fee is $0.75 and the transaction fee as determined at step 904 is less than $0.75, then, at step 905a the transaction fee would be reset to $0.75.

Sub-step 905b represents setting the transaction fee to a predetermined maximum transaction fee in the event the transaction fee, as determined at step 904 is above a threshold equal to the maximum transaction fee. For example, if the predetermined maximum transaction fee is $20.00 and the transaction fee as determined at step 904 is above $20.00, then, at step 905b the transaction fee would be reset to $20.00.

Returning to FIG. 10a, step 186 represents the payment bureau 10 generating disbursement instructions 186 and 188 to the payment system 30a to initiate: i) a debit transaction, or multiple debit transactions, to debit the payment amount from the settlement account 134 as depicted by step 190; ii) a credit transaction to credit the payment amount less the transaction fee to the vendor's transaction account as depicted by step 192; and iii) a credit transaction to credit the transaction fee to the operator account 37 as depicted by step 194.

The debit(s) of the settlement account and credits to the vendor's transaction account and operator account by funds transfer if between accounts held at the same bank or by transfer through a settlement network 32 if between accounts are held at different banks.

In an alternative embodiment, the disbursements instructions 186 and 188 may each be an instruction, or a debit/credit instruction pair, sent directly by the payment application 18 the settlement network 32 (whether separate from, or part of the payment bureau 10) to effect the initiation of a debit transaction to debit the applicable amount from the settlement account and credit the amount of the payment less the transaction fee to the vendor account and to credit the transaction fee to the operator account.

As discussed, the payment bureau will complete the disbursement steps 174 for each payment within the payment file 160a, which for the second payment represented in the payment file 160a (i.e. a payment of $200 to vendor 12e) includes identifying a payment transaction fee to apply to the second payment at step 184, using the process described with respect to FIG. 11, and generating the disbursement instructions to effect the credits and debits as discussed with respect to steps 186 through 194.

Similarly for the third payment represented in the payment file 160a (i.e. a payment of $300 to vendor 12i) includes identifying a payment transaction fee to apply to the third payment at step 184, using the process described with respect to FIG. 11, and generating the disbursement instructions to effect the credits and debits as discussed with respect to steps 186 through 194.

It should be appreciated that the disbursement instructions to effect the credits and debits as discussed with respect to steps 186 through 194, for each of multiple transactions, may be grouped in batches for transmission to the payment system 30a or the settlement network 32, more specifically, the instructions associated with each of the first payment, second payment, and third payments may be transmitted at the same time as part of a batch.

Although the foregoing description of the funding instructions 173 contemplate funding the settlement account for the aggregate amount of all payments within the payment file through a single funding transaction. In an alternative, the funding instructions 173 may be independently performed for each payment within the payment file, in each case funding only the amount of the particular payment to the settlement account.

After disbursement instructions 174 are executed for each payment within the payment file 160, rebate instructions 175 may be executed for calculating and paying a rebate to the payer. More specifically, step 196 represents calculating a rebate due to the payer.

In a preferred embodiment, the rebate steps 175 may be performed only after multiple payment files are received from the payer over a set period of time, for example payment steps 175 may be performed only once per month for calculating a rebate based on the group of all payments made by the payer during the previous month period preceding the calculation and payment of the rebate. However, other embodiments are contemplated. For example, the payment bureau 10 may perform the rebate steps 175 once per payment, meaning the payment bureau 10 may calculate and disburse a rebate to the payer on each payment within the payment file.

Alternatively, the payment bureau 10 may perform the rebate steps 175 once for all payments within the payment file, meaning the payment bureau 10 may calculate and disburse a rebate to the payer based at least in part on the aggregate of the payments, or the aggregate amount of the payments, within the payment file.

In yet another alternative, the rebate steps 175 may be performed only after multiple payment files are received from the payer which in the aggregate total a certain payment value. For example the aggregate value of all payments made by the payer achieves a threshold value which triggers performance of the payment steps 175 and payment of a rebate based on payments used for calculating the aggregate total.

Turning to FIG. 12, exemplary steps for determining a rebate amount in an embodiment where the rebate steps 175 are performed only after multiple payment files are received from the payer over a set period of time are shown.

Step 906 represents determining the total transaction fee. The total transaction fee is the sum of the transaction fee charged on each payment made by the payer over the set period of time.

Step 908 represents determining the amount of the rebate. The rebate amount may be a fraction of the total transaction fee, the fraction being less than one. Or, stated another way, the rebate amount on the aggregate of a group of payments made by the payer may be a fraction of the sum of the aggregate transaction fees applied to the each payment of the group of payments, or a fraction of the of the aggregate transaction fees applied to each payment of the group of payments above a minimum transaction fee threshold.

More specifically, step 908 may represent determining a rebate amount, the rebate amount being the sum of: i) a base rebate calculated at step 908a to be the product of the total transaction fee multiplied by a base rebate fractional value between zero and one; and ii) an accelerated rebate calculated at step 908b to be the product of that portion of the total transaction fee in excess of a predetermined threshold value multiplied by an accelerated rebate fractional value between zero and one.

Returning to FIG. 10a, after the amount of the rebate is determined, the payment bureau 10 may generate a rebate instruction 198 to the payment system 30a to initiate: i) a debit transaction to debit the amount of the rebate from the operator account 34 as depicted by step 200 and ii) a credit transaction to credit the amount of the rebate to the payer's account as depicted by step 202.

Again, the debit(s) of the operator account and credit to the payer's account may be by funds transfer if between accounts held at the same bank or by transfer through a settlement network 32 if between accounts are held at different banks.

In an alternative embodiment, the rebate instruction 198 may be an instruction, or a debit/credit instruction pair, sent directly by the payment application 18 the settlement network 32 (whether separate from, or part of the payment bureau 10) to effect the initiation of a debit transaction to debit the rebate amount from the operator account and credit the rebate amount to the payer's account.

Referring to the ladder diagram of FIG. 10b in conjunction with FIG. 1, in yet another exemplary embodiment of operation, the payment bureau 10 receives a payment file, for example payment file 160b (FIG. 9b) from payer 14b, as represented by step 22. The payment instruction file may be transferred via a secure connection over the network 20 which may include implementing encryption of the connection and/or the file transferred over the connection.

Upon receiving and authenticating the payment file 160, the payment bureau 10, or more specifically, the processor 40 executing the payment application 18, performs payment steps 171 for each payment represented in the payment file 160. Step 184 represents determining the payment transaction fee to apply to the payment as discussed with respect to FIG. 11.

The payment bureau then generates payment instruction 220 to the payment system 30a to initiate: i) a debit transaction to debit the payment amount from the payer's account as depicted by step 226; ii) a credit transaction to credit the payment amount less the transaction fee to the vendor's transaction account as depicted by step 224; and iii) a credit transaction to credit the transaction fee to the operator account 37 as depicted by step 226.

Again, the debit(s) of the payers transaction account and credits to the vendor's transaction account and operator account by funds transfer if between accounts held at the same bank or by transfer through a settlement network 32 if between accounts held at different banks.

Again, the payment instruction 220 may be an instruction, or a debit/credit instruction combination, sent directly by the payment application 18 to the settlement network 32 (whether distinct from the payment bureau 10 or part of the payment bureau 10) to effect the initiation of a debit transaction to debit the applicable amount from the payers transaction account and credit the amount of the payment less the transaction fee to the vendor transaction account and to credit the transaction fee to the operator account.

After disbursement steps 171 are executed for each payment within the payment file 160, rebate steps 175 may be executed for calculating and paying a rebate to the payer. More specifically, step 196 represents calculating a rebate due to the payer in the manner discussed with respect to FIG. 12. After the amount of the rebate is determined, the payment bureau 10 may generate a rebate instruction 198 to the payment system 30a to initiate: i) a debit transaction to debit the amount of the rebate from the operator account 34 as depicted by step 200 and ii) a credit transaction to credit the amount of the rebate to the payer's account as depicted by step 202.

Referring to the ladder diagram of FIG. 10c in conjunction with FIG. 1, in an exemplary embodiment of operation, the payment bureau 10 receives a payment file, for example payment file 160a (FIG. 9a) from payer 14a, as represented by step 22. The payment instruction file may be transferred via a secure connection over the network 20 which may include implementing encryption of the connection and/or the file transferred over the connection.

Upon receiving and authenticating the payment file 160, the payment bureau 10, or more specifically, the processor 40 executing the payment application 18, performs funding steps 173 to transfer a funding amount equal to the aggregate or sum of the amount of all payments in the payment file 160 from the payer's account (account 36a at bank 28a) to the settlement account 34 as described in more detail with respect to FIG. 10a.

After the funding amount is received in the settlement account 34, disbursement steps 174 are performed for each payment represented in the payment file. In executing the disbursement steps 174 for a payment, the payment bureau 10 identifies a payment transaction fee to apply to the payment at step 184 as described with respect to FIG. 11.

Step 186 represents the payment bureau 10 generating disbursement instructions 186 and 188 to the payment system 30a to initiate: i) a debit transaction, or multiple debit transactions, to debit the payment amount from the settlement account 134 as depicted by step 190; ii) a credit transaction to credit the payment amount to the vendor's transaction account as depicted by step 192; iii) a debit transaction to debit the transaction fee from the vendor's transaction account as depicted at step 193; and iv) a credit transaction to credit the transaction fee to the operator account 37 as depicted by step 194.

The debit(s) of the settlement account, credits and debits to the vendor's transaction account, and credits to operator account by funds transfer if between accounts held at the same bank or by transfer through a settlement network 32 if between accounts are held at different banks.

In an alternative embodiment, the disbursements instructions 186 and 188 may each be an instruction, or a debit/credit instruction pair, sent directly by the payment application 18 the settlement network 32 (whether separate from, or part of the payment bureau 10) to effect the initiation of a debit transaction to debit the applicable amount from the settlement account, credit the amount of the payment to the vendor account, debit the amount of the transaction fee from the vendor account, and to credit the transaction fee to the operator account.

As discussed, the payment bureau will complete the disbursement steps 174 for each payment within the payment file 160a, which for the second payment represented in the payment file 160a (i.e. a payment of $200 to vendor 12e) includes identifying a payment transaction fee to apply to the second payment at step 184, using the process described with respect to FIG. 11, and generating the disbursement instructions to effect the credits and debits as discussed with respect to steps 186 through 194.

Similarly for the third payment represented in the payment file 160a (i.e. a payment of $300 to vendor 12i) includes identifying a payment transaction fee to apply to the third payment at step 184, using the process described with respect to FIG. 11, and generating the disbursement instructions to effect the credits and debits as discussed with respect to steps 186 through 194.

It should be appreciated that the disbursement instructions to effect the credits and debits as discussed with respect to steps 186 through 194, for each of multiple transactions, may be grouped in batches for transmission to the payment system 30a or the settlement network 32, more specifically, the instructions associated with each of the first payment, second payment, and third payments may be transmitted at the same time as part of a batch.

After disbursement instructions 174 are executed for each payment within the payment file 160, rebate instructions 175 may be executed for calculating and paying a rebate to the payer as describe with respect to FIG. 12.

Referring to the ladder diagram of FIG. 10d in conjunction with FIG. 1, in yet another exemplary embodiment of operation, the payment bureau 10 receives a payment file, for example payment file 160b (FIG. 9b) from payer 14b, as represented by step 22. The payment instruction file may be transferred via a secure connection over the network 20 which may include implementing encryption of the connection and/or the file transferred over the connection.

Upon receiving and authenticating the payment file 160, the payment bureau 10, or more specifically, the processor 40 executing the payment application 18, performs payment steps 171 for each payment represented in the payment file 160. Step 184 represents determining the payment transaction fee to apply to the payment as discussed with respect to FIG. 11.

The payment bureau then generates payment instruction 220 to the payment system 30a to initiate: i) a debit transaction to debit the payment amount from the payer's account as depicted by step 226; ii) a credit transaction to credit the payment amount to the vendor's transaction account as depicted by step 224; iii) a debit transaction to debit the transaction fee from the vendors account as depicted by step 225; and iv) a credit transaction to credit the transaction fee to the operator account 37 as depicted by step 226.

Again, the debit(s) of the payers transaction account, credits and debits to the vendor's transaction account, and credits to the operator account may be by funds transfer if between accounts held at the same bank or by transfer through a settlement network 32 if between accounts held at different banks.

Again, the payment instruction 220 may be an instruction, or a debit/credit instruction combination, sent directly by the payment application 18 to the settlement network 32 (whether distinct from the payment bureau 10 or part of the payment bureau 10) to effect the initiation of a debit transaction to debit the applicable amount from the payers transaction account, credit the amount of the to the vendor transaction account, debit the amount of the transaction fee from the vendor's transaction account, and credit the amount of the transaction fee to the operator account.

After disbursement steps 171 are executed for each payment within the payment file 160, rebate steps 175 may be executed for calculating and paying a rebate to the payer as described with respect to FIG. 12.

In summary, the present invention provides a system for making payments from a payer to a community of vendors, assessing a variable transaction fee to each vendor, and providing a variable rebate to the payer. Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

1-10. (canceled)

11. A system for making payments from a payer of a group of payers to a vendor of a group of vendors, assessing a payer transaction fee to the vendor, and providing a rebate to the payer, the system comprising:
data stored in a non-transitory computer readable medium, the data including:
records associating each payer of the group of payers with identification of a group of transaction rates to apply to payments made by the payer, each transaction rate of the group of transaction rates being a rate distinct from the other transaction rates of the group of transaction rates;
records associating each transaction rate of the group of transaction rates with identification of a payer rate subgroup of vendors to which the transaction rate applies, the payer rate subgroup of vendors being a group of vendors that is mutually exclusive of the group of vendors in each other payer rate subgroup of vendors;
a group of payment instructions, each payment instruction including identification of a transaction payer, identification of a transaction vendor, and identification of a transaction payment amount, the transaction payer being one of the payers of the group of payers and the transaction vendor being one of the vendors within one of the payer rate subgroup of vendors associated with the transaction payer;
a payment application comprising instructions stored in a non-transitory computer readable memory and executed by a processor, the instructions comprising:
in response to receipt of each payment instruction, generating a credit for a payment amount to an account of the transaction vendor, the payment amount being the transaction payment amount less a payer determined transaction fee, the payer determined transaction fee being the transaction payment amount multiplied by the transaction rate that is associated with the payer subgroup of vendors to which the first vendor is associated.

12. The system of claim 11, further comprising a rebate application, the rebate application comprising instructions stored in a non-transitory computer readable memory and executed by a processor, the instructions comprising:
for each payer, calculating a rebate applicable to a predetermined period of time, calculating the rebate comprising:
determining a total transaction fee, the total transaction fee being the sum of each payer determined transaction fee applied to each payment made by the payer during the predetermined period of time;
determining a rebate amount, the rebate amount being the product of the total transaction fee multiplied by a rebate fractional value between zero and one;
crediting, to the account of the payer, the rebate amount.

13. The system of claim 12, wherein crediting the payment amount to the account of the transaction vendor comprises:
crediting to the account of the transaction vendor the transaction payment amount; and
debiting from the account of the transaction vendor the payer determined transaction fee.

14. The system of claim 11, further comprising a rebate application, the rebate application comprising instructions stored in a non-transitory computer readable memory and executed by a processor, the instructions comprising:
for each payer, calculating a rebate applicable to a predetermined period of time, calculating the rebate comprising:
determining a total transaction fee, the total transaction fee being the sum of each payer determined transaction fee applied to each payment made by the payer during the predetermined period of time;
determining a rebate amount, the rebate amount being the sum of:
the product of the total transaction fee multiplied by a base rebate fractional value between zero and one; and
the product of that portion of the total transaction fee in excess of a predetermined threshold value multiplied by an accelerated rebate fractional value; and
crediting, to the account of the payer, the rebate amount.

15. The system of claim 14, wherein crediting the payment amount to the account of the transaction vendor comprises:
crediting to the account of the transaction vendor the transaction payment amount; and
debiting from the account of the transaction vendor the payer determined transaction fee.

16-20. (canceled)
